(19) United States
(12) Patent Application Publication
(10) Pub. No.: US 2004/0006573 A1
(43) Pub. Date: Jan. 8, 2004

(54) Data transmission apparatus, data transmission method, and data transmission method program

(76) Inventor: Nomura Takashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,413

(22) PCT Filed: Jun. 17, 2002
(86) PCT No.: PCT/JP02/06011

(30) Foreign Application Priority Data
Jun. 18, 2001 (JP) 2001-183182

(51) Int. Cl. G06F 17/00

(52) U.S. Cl. 707/104.1

(57) ABSTRACT

The present invention is applied, for example, to a gateway apparatus in a home network. The content of a command transferred according to a control protocol is changed, if necessary, and the command is relayed.

### BACKGROUND OF INVENTION

1. Technical Field

The present invention relates to data transfer apparatuses, data transfer methods, and programs for data transfer methods, and can be applied, for example, to a gateway apparatus in a home network. The present invention allows streaming contents and others to be easily transferred while security is sufficiently ensured by a firewall, by appropriately changing the content of a command sent according to a control protocol and relaying the command.

2. Background Art

In the Internet and others, conventionally, contents such as video data are transferred according to RTP (real-time transport protocol), which is a transport protocol for transferring streaming, and executes exchanges of information such as a port number used for content transfer, setting and release of a session, control of content distribution, and others according to RTSP (real-time streaming protocol), which is a control protocol.

Local area networks and others are connected to the Internet and others through routers. Firewalls are configured by the routers and further by gateway apparatuses.

To transfer a content through such a firewall, it is necessary to set an IP address and a port number converted at the firewall so as to correspond to the IP address and the port number of a server and a client terminal described in RTSP. Since RTSP dynamically determines the port number used by RTP, however, the port number does not have a default value. Therefore, it is difficult to pass a content through a firewall when the content is transferred by RTP.

Consequently, routers use a proxy RTSP server to terminate a request of RTSP, and access a server to set an IP address and a port number appropriately.

To provide a proxy RTSP server, however, it is necessary for a gateway to have a usual RTSP-server function. This makes the structure complicated. The corresponding settings are also required in a client terminal. This may make the user perform troublesome setting work.

### DISCLOSURE OF INVENTION

The present invention has been made in consideration of the above-described points. The present invention proposes a data transfer apparatus, a data transfer method, and a program for a data transfer method which allow streaming contents and others to be easily transferred while security is sufficiently ensured by a firewall.

To solve the foregoing problems, the present invention is applied to a data transfer apparatus. When data input-and-output means receives a command sent according to a control protocol, a parameter related to a transport protocol is changed in the command, the command having the changed parameter and sent according to the control protocol is transmitted through the data input-and-output means, and the changed parameter related to the transport protocol is stored in storage means. When the data input-and-output means receives data sent according to the transport protocol, relay processing is applied to the data according to the parameter stored in the storage means.

According to a structure of the present invention, the present invention is applied to a data transfer apparatus; when data input-and-output means receives a command sent according to a control protocol, a parameter related to a transport protocol is changed in the command, the command having the changed parameter and sent according to the control protocol is transmitted through the data input-and-output means, and the changed parameter related to the transport protocol is stored in storage means; and when the data input-and-output means receives data sent according to the transport protocol, relay processing is applied to the data according to the parameter stored in the storage means. Therefore, even when a port number to be used by the transport protocol is dynamically assigned by a server and a client related to data transfer, the port number is obtained to enable passing through a firewall. With this, streaming contents and others can be easily transferred while security is sufficiently provided by the firewall.

In addition, the present invention is applied to a data transfer method, and the method includes a control-protocol relay step of applying relay processing to a command transmitted and received according to a control protocol between first and second terminals belonging to first and second networks, respectively, and of setting a parameter used for a transport protocol according to which data is transferred between the first and second terminals, according to a parameter in the command; and a transport-protocol relay step of applying relay processing to data transfer performed according to the transport protocol between the first and second terminals, according to the parameter specified in the control-protocol relay step, and, in the control-protocol relay step, a parameter related to the transport protocol and disposed in the command sent according to the control protocol is changed, and the changed command sent according to the control protocol is output.

With this, according to a structure of the present invention, a data transfer method in which streaming contents and others can be easily transferred while security is sufficiently provided by a firewall is provided.

Further, the present invention is applied to a program for a data transfer method, and the program includes a control-protocol relay step of applying relay processing to a command transmitted and received according to a control protocol between first and second terminals belonging to first and second networks, respectively, and of setting a parameter used for a transport protocol according to which data is transferred between the first and second terminals, according to a parameter in the command; and a transport-protocol relay step of applying relay processing to data transfer performed according to the transport protocol between the first and second terminals, according to the parameter specified in the control-protocol relay step, and, in the control-protocol relay step, a parameter related to the transport protocol and disposed in the command sent according to the control protocol is changed, and the changed command sent according to the control protocol is output.

With this, according to a structure of the present invention, a program for a data transfer method in which streaming contents and others can be easily transferred while security is sufficiently provided by a firewall is provided.

### BRIEF DESCRIPTION OF THE DRAWINGS

FIG. 1 is a block diagram of a content transfer system according to an embodiment of the present invention.

FIG. 2 is a flowchart for describing the operation of a gateway apparatus in the streaming-content transfer system shown in FIG. 1.

FIG. 3 is a flowchart which shows subsequent steps of steps shown in FIG. 2.

FIG. 4 is a flowchart of response processing in the gateway apparatus shown in FIG. 1.

FIG. 5 is a flowchart which shows subsequent steps of steps shown in FIG. 4.

FIG. 6 is a flowchart of processing for a response from a local area network.

FIG. 7 is a flowchart which shows subsequent steps of steps shown in FIG. 6.

FIG. 8 is a flowchart of a processing procedure for a TEARDOWN-command response.

FIG. 9 is a flowchart of a processing procedure for relay processing of commands and others.

### BEST MODE FOR CARRYING OUT THE INVENTION

Embodiments of the present invention will be described below in detail by referring to the drawings, if necessary.

(1) Structure of embodiment

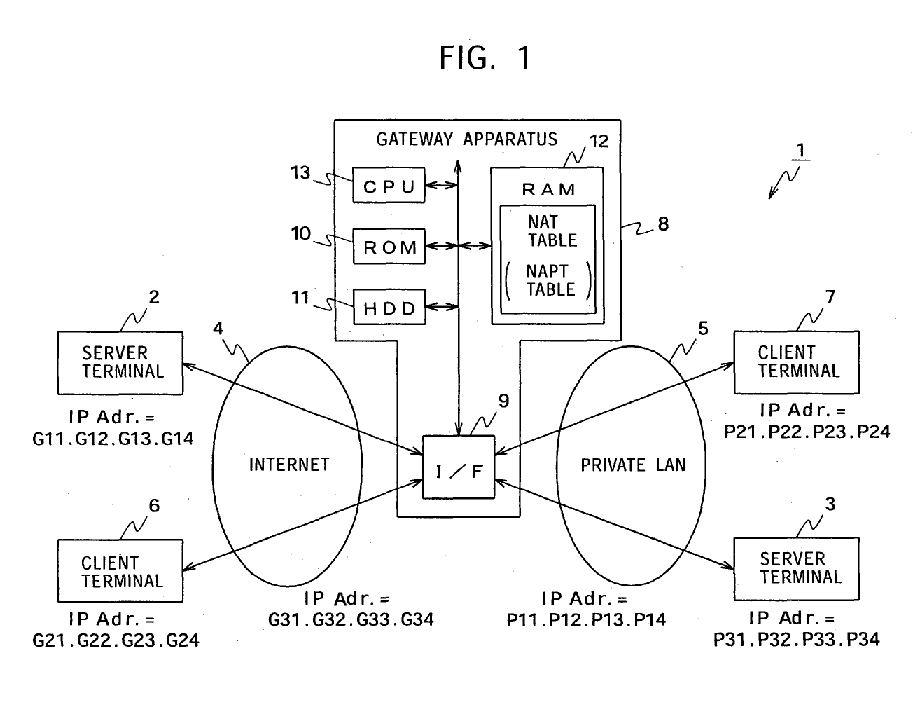

FIG. 1 is a block diagram showing a streaming-content transfer system according to an embodiment of the present invention. In the streaming-content transfer system 1, server terminals 2 and 3 each are connected to the Internet 4, which is a global network, and also to a local area network (private LAN) 5, which is a private network, return a response in response to a command obtained from each of the networks 4 and 5, and further send streaming-content data.

In contrast to the server terminals 2 and 3, client terminals 6 and 7 each are connected to the Internet 4 and the local area network 5, and send a streaming-content transfer request and others to each network. The server terminals 2 and 3 and the client terminals 6 and 7 are configured such that, during the above-described processes, RTP (real-time transport protocol) transfers contents, and RTSP executes exchanges of information such as a port number used for content transfer, setting and release of a session, control of content distribution, and others.

The local area network 5 is, for example, a home network, and is connected to a gateway apparatus 8, the server terminal 3, and the client terminal 7. Its private address spaces are set to (10.0.0.0 to 10.255.255.255), (172.16.0.0 to 172.31.255.255), and (192.168.0.0 to 192.168.255.255).

The gateway apparatus 8 is a computer which is connected between the Internet 4 and the local area network 5, serving as first and second networks, and which transmits and receives data between the networks. In other words, the gateway apparatus 8 is configured so as to be able to input and output data through an interface (I/F) 9 between the Internet 4 and the local area network 5. The gateway apparatus 8 obtains a working area in a random access memory 12 and executes a predetermined application program stored in a hard disk drive (HDD) 11 by a central processing unit (CPU) 13 according to recordings of a read-only memory (ROM) 10 to process data input through the interface 9 and to output through the interface 9 to the local area network 5 and the Internet 4. With these operations, the gateway apparatus 8 functions as an application gateway between the Internet 4 and the local area network 5, and also forms a firewall for the local area network 5.

With this, the gateway apparatus 8 executes the application program recorded in the hard disk drive 11 by the central processing unit 13 to record parameters required for transferring a command and data according to a transport protocol, to update a NAT (network address translation) table or a NAPT (network address port translation) table 12A and others formed in the random access memory 12, and also to execute a series of processing procedures, described later.

With this, in the gateway apparatus 8, the interface 9 is configured to serve as data input-and-output means connected to the client terminal 7 and the server terminal 3, and to the client terminal 6 and the server terminal 2, which are first and second terminals belonging respectively to the first and second networks, through the first and second networks. Together with the read-only memory 10, the hard disk drive 11, and the random access memory 12, the central processing unit 13 is configured to serve as data processing means which processes data input from the first and second terminals through the data input-and-output means and outputs to the second and first terminals through the data input-and-output means by the application gateway function and the firewall function.

During these processes, the gateway apparatus 8 relays various commands by TCP (transmission control protocol) and UDP (user datagram protocol) between the local area network 5 and the Internet 4. At this time, the gateway apparatus 8 forms a firewall by a filtering process which uses addresses. Since a fixed port number of 554 is assigned to RTSP in TCP, the gateway apparatus 8 can easily detect various RTSP commands and execute corresponding processes.

Therefore, the gateway apparatus 8 uses a command and others obtained through the local area network 5 and the Internet 4 to update recordings of the NAT table or the NAPT table 12A, which shows address correspondence between the two networks; converts a private address in a command or others obtained from the local area network 5 to a global address in the Internet 4 by a NAT function or a multi-NAT function according to the recordings of the NAT table or the NAPT table 12A and sends it to the Internet 4; and, conversely, converts a global address in a command or others obtained from the Internet 4 to a private address and sends to the local area network 5. With this, the gateway apparatus 8 is configured so as to update the content of a command or others by RTSP, if necessary, and relays it, and also to be able to transfer content data by RTP.

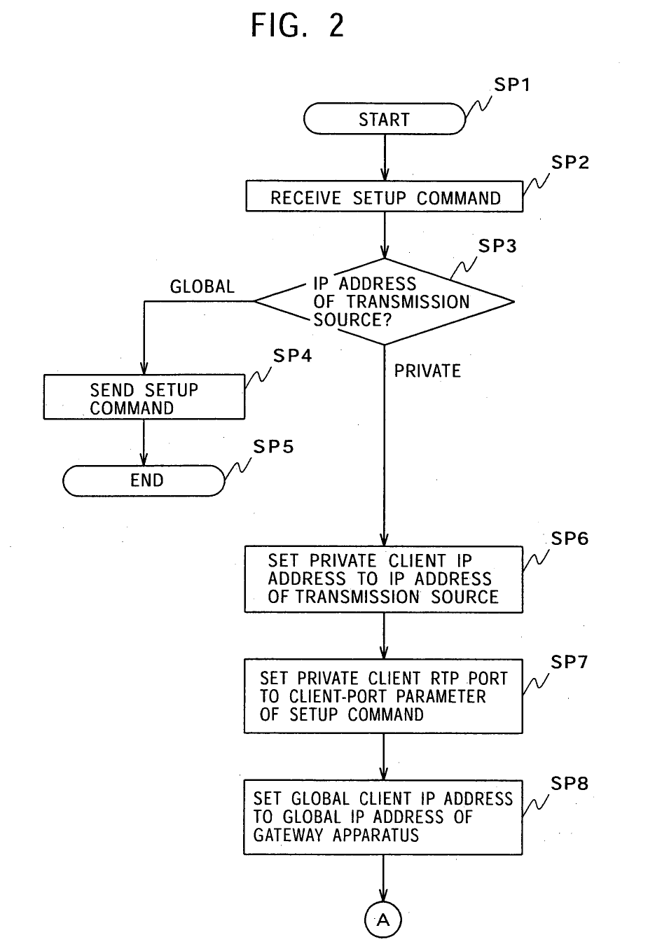

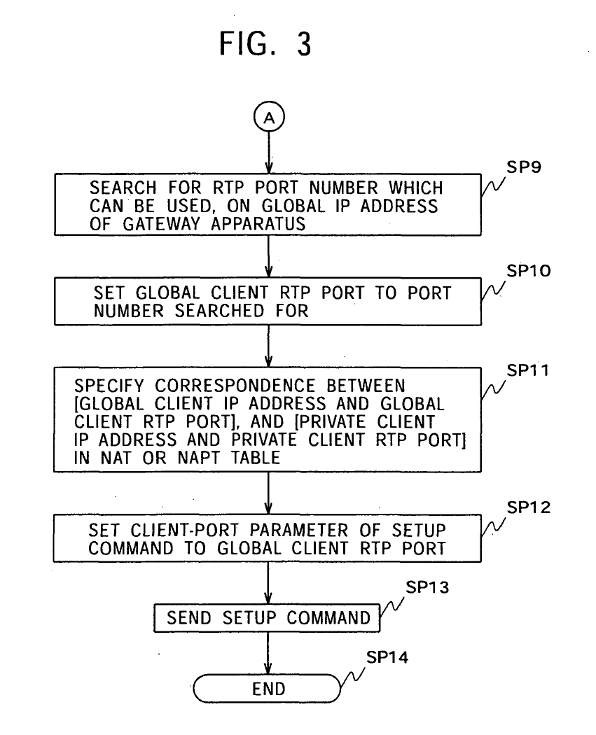

FIG. 2 and FIG. 3 show a flowchart of a processing procedure of the gateway apparatus 8 for a process for updating the NAT table or the NAPT table 12A. The gateway apparatus 8 monitors packets on the Internet 4 and the local area network 5; and when the client terminal 6 or 7 sends an RTSP setup command in each of the networks 4 and 5, the gateway apparatus 8 executes the processing procedure. A setup command is a command which the client terminal 6 or 7 sends to request content distribution or others.

In other words, the procedure proceeds from step SP1 to step SP2, and the gateway apparatus 8 receives a setup command. Then, in step SP3, the gateway apparatus 8 determines the IP address of a transmission source specified in this packet. When the IP address of the transmission source is a global address, the procedure proceeds to step SP4, and the gateway apparatus 8 sends a setup command to the server terminal 3, which is installed in a private space according to a prior setting. Then, the procedure proceeds to step SP5. With these operations, the gateway apparatus 8 relays the RTSP setup command sent from the global space to send to the local area network 5.

In contrast, when the IP address of the transmission source is a private address, the procedure proceeds from step SP3 to step SP6, and the gateway apparatus 8 sets a private client IP address indicating the IP address of the client terminal 7 in the local area network 5 to the IP address of the transmission source, obtained from the setup command. The private client IP address is a parameter in a management data base used in the application gateway function.

Then, the procedure proceeds to step SP7, and the gateway apparatus 8 sets a private client RTP port to the parameter of a client port specified in the setup command. The private client RTP port indicates a port number used by the client terminal 7 in RTP on the local area network 5, and is assigned by the client terminal 7 for RTP.

Then, the procedure proceeds to step SP8, and the gateway apparatus 8 sets a global client IP address, which is a parameter in the management data base, to the global IP address of the gateway apparatus 8. The procedure then proceeds to step SP9 (in FIG. 3), and the gateway apparatus 8 searches for a port number which can be used for RTP; corresponding to the global IP address of the gateway apparatus 8. In the following step SP10, the gateway apparatus 8 sets a global client RTP port, which is a parameter in the management data base, to a found value.

Then, the procedure proceeds to step SP11, and the gateway apparatus 8 records in the NAT table or the NAPT table 12A the correspondence between the global client IP address and the global client RTP port, and the private client IP address and the private client RTP port, so that the IP address and the port number of an RTP packet are set to be able to be converted. When it is set in this way that an RTP packet can be relayed from the network 5 to the network 4, the procedure proceeds to step SP12, and the gateway apparatus 8 sets the client-port parameter of the received setup command to the global client RTP port parameter recorded in the management data base. In the following step SP13, the gateway apparatus 8 sends the setup command to the Internet 4. The procedure proceeds to step SP14 and the processing procedure is terminated. With these operations, the gateway apparatus 8 sets an address in the setup command sent from the local area network 5 as if the gateway apparatus 8 first sent the command, and sends it to the Internet 4 to relay the setup command.

The parameters specified in this processing procedure and parameters described later are associated with each session ID assigned in subsequent processing independently.

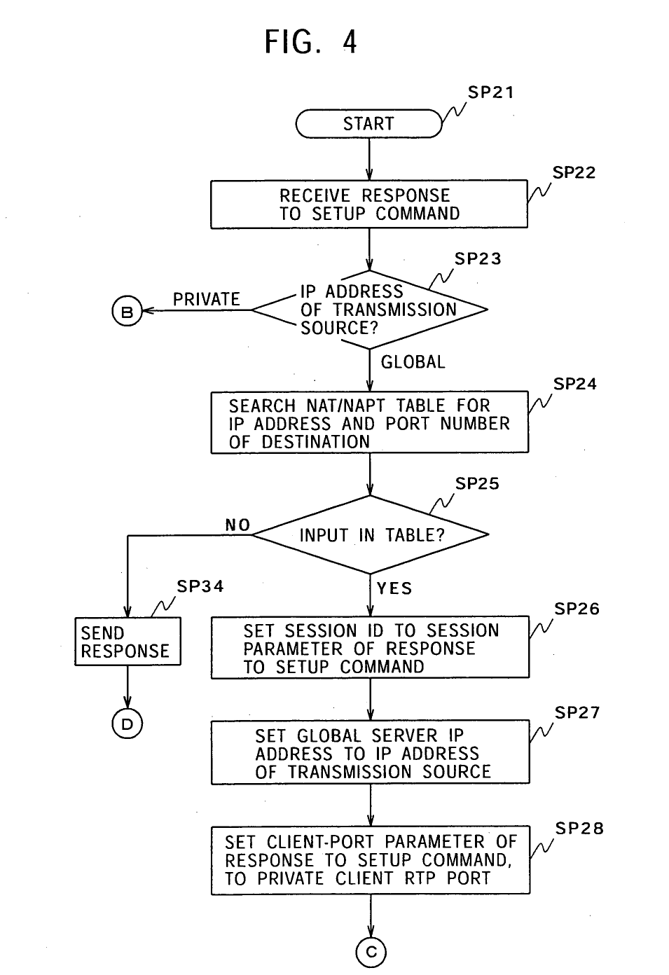

In contrast, FIG. 4 to FIG. 7 show a flowchart of processing of a response, which is a command obtained by the corresponding server terminals 2 and 3 in response to the relay of the setup command, described above. The gateway apparatus 8 executes the processing, which forms a pair with the above-described setup-command processing, to set the NAT table or the NAPT table 12A such that RTP transfer of streaming contents is allowed between the local area network 5 and the Internet 4.

More specifically, when a response to the setup command is obtained, the processing proceeds from step SP21 to step SP22, and the gateway apparatus 8 receives the response. Then, in step SP23, the gateway apparatus 8 determines the IP address of a transmission source, specified in the response. When the IP address of the transmission source is a global address, the processing proceeds from step SP23 to step SP24, and the gateway apparatus 8 searches the NAT table or the NAPT table 12A for the IP address and the port number of a corresponding destination.

In the following step SP25, the gateway apparatus 8 determines from a search result whether the IP address of the destination has been input in the table or not. When a positive result is obtained, the processing proceeds to step SP26. The gateway apparatus 8 sets a session ID parameter in the management data base to a session ID parameter of the response to the setup command.

In the further following step SP27, the gateway apparatus 8 sets a global server IP address to the IP address of the transmission source in the management data base. In the next step SP28, the gateway apparatus 8 sets a client-port parameter specified in the received response to the private client RTP port recorded in the management data base.

Then, in the next step SP29, the gateway apparatus 8 associates the session ID of the response to a searched-for entry of the setup command and records them.

In the following step SP30, the gateway apparatus 8 adds the global server IP address recorded in the management data base to the filtering condition of a firewall. In the next step SP31, the gateway apparatus 8 sets such that packets are allowed to pass through the firewall for the entry for which the NAT table or the NAPT table has been searched. With this, the gateway apparatus 8 sets such that the local area network 5 can obtain an RTP streaming content sent from the server terminal 2, which is outside the firewall, while the firewall function is maintained.

In the next step SP32, the gateway apparatus 8 sends the setup command in which the address has been changed as described above, to the local area network 5. Then, the processing proceeds to step SP33, and the processing procedure is terminated. With this processing, the gateway apparatus 8 changes the address in the RTP response and relays the response from the Internet 4 to the local area network 5.

In contrast, when the IP address of the transmission source has not yet been input in the table, the processing proceeds from step SP25 to step SP34, and the gateway apparatus 8 sends the received response without any processing to the local area network 5 to relay the response.

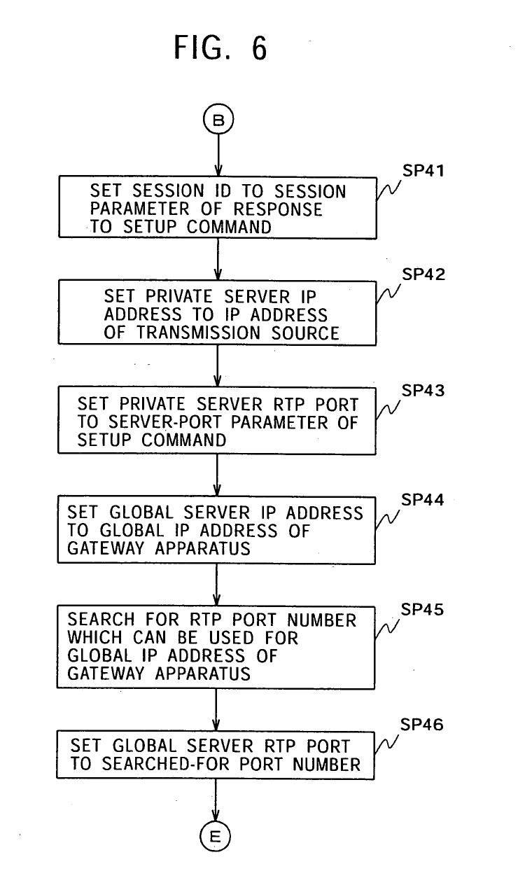

In contrast, when the transmission-source address of the received response is a private IP address, the processing proceeds from step SP25 to step SP41 (in FIG. 6). In step SP41, the gateway apparatus 8 sets the session ID parameter in the management data base to the session ID parameter of the received response. In the following step SP42, the gateway apparatus 8 sets the private server IP address to the IP address of the transmission source. In the next step SP43, the gateway apparatus 8 further sets the private server RTP port to the server port of the corresponding setup command. The private server RTP port is the number of a port which the server terminal 3 uses on the local area network 5 in RTP.

In the following step SP44, the gateway apparatus 8 sets the global server IP address in the management data base to the global IP address of the gateway apparatus 8. Then, the processing proceeds to step SP45, and the gateway apparatus 8 searches for a port number which can be used in RTP, corresponding to the global IP address. In step SP46, the gateway apparatus 8 sets the global server RTP port, which is a parameter in the management data base, to a searched-for port number.

In the following step SP47, the gateway apparatus 8 records in the NAT table or the NAPT table 12A the correspondence between the global server IP address and the global server RTP port, and the private server IP address and the private server RTP port, specified as described above, so that the IP address and the port number of an RTP packet are set to be able to be converted.

Then, in step SP48, the gateway apparatus 8 associates the session ID of the response with a searched-for entry of the setup command and records them.

In the following step SP49, the gateway apparatus 8 sets the server-port parameter of the received response to the global server RTP parameter recorded in the management data base.

In the next step SP49, the gateway apparatus 8 sets such that packets are allowed to pass through the firewall for the specified entry. With this, the gateway apparatus 8 sets such that the Internet 4 can obtain an RTP streaming content sent from the server terminal 3, which is inside the firewall, while the firewall function is maintained.

In the next step SP51, the gateway apparatus 8 sends the setup command in which the address has been changed as described above, to the Internet 4. Then, the processing proceeds to step SP52, and the processing procedure is terminated. With this processing, the gateway apparatus 8 changes the address in the RTSP response and relays the response from the local area network 5 to the Internet.

The gateway apparatus 8 records and holds the addresses and the port numbers corresponding to the clients, the servers, and the gateway apparatus 8 in the two address spaces, the private space and the global space, in the NAT table or the NAPT table 12A for each session according to the setup command and the response to the setup command; changes the contents (address and port number) of RTP commands by similar processing based on recordings of the NAT table or the NAPT table 12A to relay the commands; and further relays streaming contents by RTP.

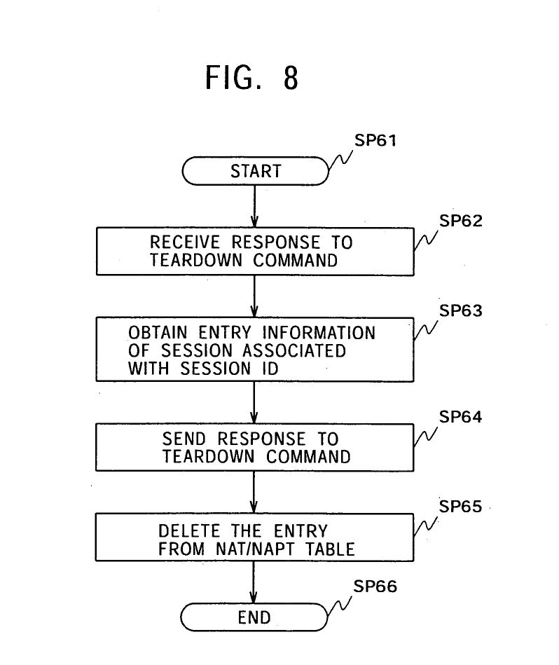

In this series of processing, when a response to a TEARDOWN command, which indicates the termination of a session, is obtained, the processing proceeds from step SP61 to step SP62 shown in FIG. 8, and the gateway apparatus 8 receives the response to the TEARDOWN command. In the following step SP63, the gateway apparatus 8 accesses the management data base with the use of a session-ID parameter corresponding to a session ID recorded in the response to obtain each entry information of a session related to the response.

Then, the processing proceeds to step SP64, and the gateway apparatus 8 sends the received response as is. In the next step SP65, the gateway apparatus 8 deletes the entry corresponding to the entry information from the NAT table or the NAPT table 12A. The processing proceeds to step SP66, and the processing procedure is terminated.

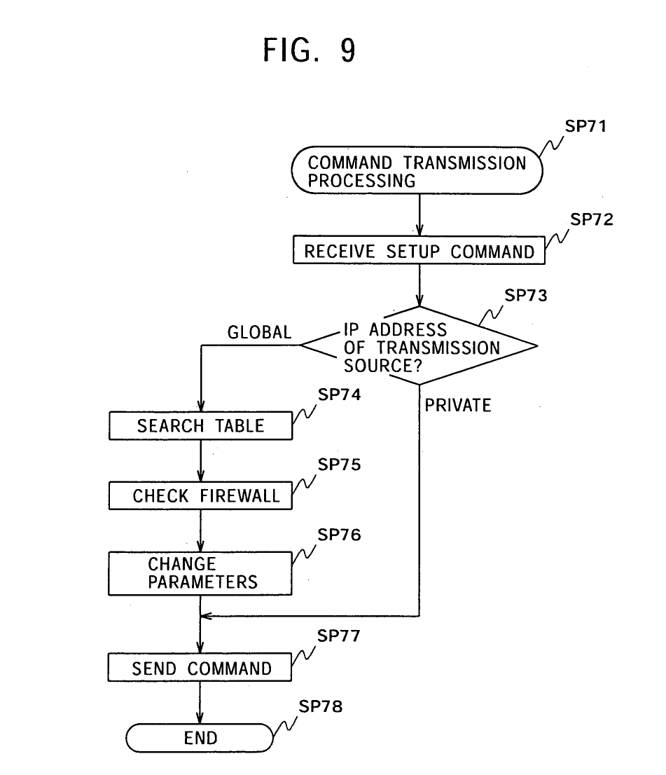

FIG. 9 is a flowchart of a command-transmission processing procedure which uses the NAT table or the NAPT table 12A updated, if necessary, as described above. In this processing procedure, the procedure proceeds from step SP71 to step SP72, and the gateway apparatus 8 receives a command. In the next step SP73, the gateway apparatus 8 determines the IP address of a transmission source, specified in the command. When the IP address of the transmission source is a global address, the processing proceeds from step SP73 to step SP74, and the gateway apparatus 8 searches the NAT table or the NAPT table 12A for the IP address and the port number of the corresponding destination.

Then, in the following step SP75, the gateway apparatus 8 determines from the searched-for port number, the IP address of the transmission source, and a port number, a session ID, and others added to the command whether a filtering condition for the firewall is satisfied. When it is determined that the command is allowed to pass through the firewall, the gateway apparatus 8 changes parameters added to the command in the next step SP76 in the same way as in the response processing described above for steps SP26 to SP31, by using various parameters detected in the NAT table or the NAPT table 12A. In the next step SP77, the gateway apparatus 8 sends the command in which the parameters have been changed as described above, to the private network. The procedure proceeds to step SP78, and the processing procedure is terminated.

In contrast, when the IP address of the transmission source is a private address, the procedure proceeds from step SP73 to step SP77, and the gateway apparatus 8 sends the received command to the global network 4. Then, the procedure proceeds to step SP78, and the processing procedure is terminated. The gateway apparatus 8 also relays a response to the above-described command in similar processing.

When data is transmitted and received in a session established by the transmission and receiving of such a series of commands and responses, the gateway apparatus 8 executes the same processing procedure as that shown in FIG. 9 to relay the data.

(2) Operations in the embodiment

With the above structure, in the streaming-content transfer system 1, the gateway apparatus 8 changes the addresses of various TCP and UDP commands obtained from the local area network 5 and the Internet 4, according to the NAT table or the NAPT table 12A held by the gateway apparatus 8, and sends the commands to the. Internet 4 and the local area network 5. Therefore, various terminal apparatuses connected to the local area network 5 can access the Internet 4 through the gateway apparatus 8, and the Internet 4 can access the various terminal apparatuses connected to the local area network 5 through the gateway apparatus 8.

In such command processing, the filtering process which uses the NAT table or the NAPT table 12A forms a firewall to prevent unauthorized accesses from the Internet 4, which is a global network.

In the streaming-content transfer system 1, the contents of RTP commands are changed, if necessary, by the gateway apparatus 8 and the commands are relayed between the Internet 4 and the local area network 5.

With this, even when RTP port numbers are dynamically specified by the client terminal 7 or others, streaming-content data can be transferred by RTP between the Internet 4 and the local area network 5. Therefore, streaming contents and others can be easily transferred without affecting security provided by the firewall.

More specifically, in the streaming-content transfer system 1, when a content-distribution request sent from the client terminal 7 connected to the local area network 5 causes the client terminal 7, disposed inside the firewall, to send an RTSP setup command to the server terminal 2, which is disposed outside the firewall, the gateway apparatus 8 changes a port number assigned by the client terminal 7 to the setup command for RTP to a port number which can be used by the gateway apparatus 8, and sends the setup command to the Internet 4 (shown in FIG. 2 and FIG. 4). The address and the port number of the client terminal 7 and the address and the port number of the gateway apparatus 8, all related to the transmission of the setup command, are associated with each other, and recorded in the NAT table or the NAPT table 12A.

With this, the content of the command sent from the client terminal 7, disposed in the local area network, actually, the port number, is changed, and the command is relayed from the local area network 5 to the Internet 4.

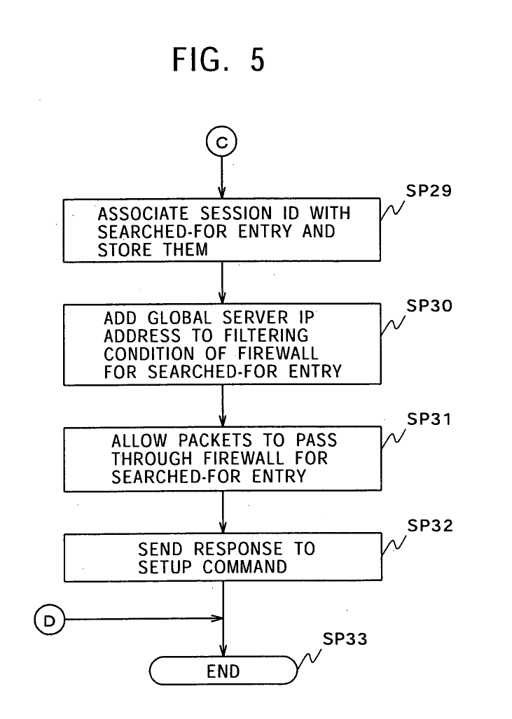

When the setup command has been relayed in this way and a response command is obtained from the server terminal 2, it is found (FIG. 4) from checking in the NAT table or the NAPT table 12A that the IP address and the port number of a destination specified in the command has been input in the NAT table or the NAPT table 12A, and as a result, the port number in the response is changed to an RTP port number of the client terminal 7 and the response is sent (FIG. 5) to the local area network 5.

With this, the content of the command sent from the server terminal 2, disposed in the Internet 4, to the client terminal 7, disposed in the local area network, inside the firewall, actually, the port number, is changed, and the command is relayed from the Internet 4 to the local area network 5.

In the streaming-content transfer system 1, with these operations, even when RTP port numbers are dynamically specified by the client terminal 7, port-number correspondence is recorded in the NAT table or the NAPT table 12A, and streaming-content data can be transferred by RTP according to the NAT table or the NAPT table 12A from the Internet 4 to the local area network 5. Therefore, streaming contents and others can be easily transferred without affecting security provided by the firewall.

In contrast, when the client terminal 6, located outside the firewall, sends a setup command to the server terminal 3, located inside the firewall (FIG. 2), the gateway apparatus 8 receives the setup command and sends the setup command to the server terminal 3 according to a prior setting.

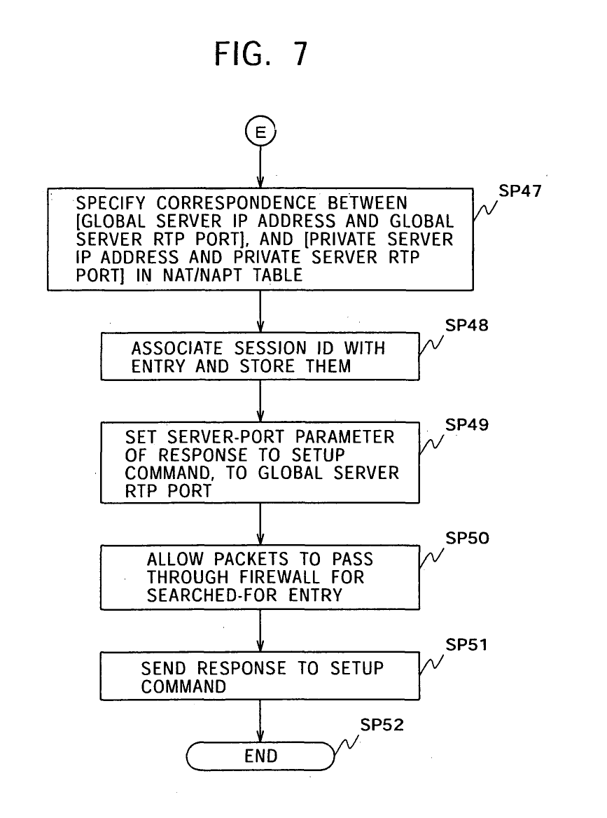

When, in response to the setup command, a response command is obtained from the server terminal 3 (FIG. 4), the port number in the response is changed to a port number which can be used by the gateway apparatus 8, and the response is sent to the Internet 4 (FIG. 6 and FIG. 7). The address and the port number of the client terminal 7 and the address and the port number of the gateway apparatus 8, all related to the transmission of the setup command, are associated with each other, and recorded in the NAT table or the NAPT table 12A.

With this, also in this case, in the streaming-content transfer system 1, even when RTP port numbers are dynamically specified by the client terminal 6, port-number correspondence is recorded in the NAT table or the NAPT table 12A, and streaming-content data can be transferred by RTP according to the NAT table or the NAPT table 12A from the local area network 5 to the Internet 4. Therefore, streaming contents and others can be easily transferred without affecting security provided by the firewall.

In these processes, passing through the firewall is dynamically enabled and disabled in the NAT table or the NAPT table 12A according to the setting and release of a session in the streaming-content transfer system 1 (FIG. 5, FIG. 7, and FIG. 8). In other words, a response to a setup command enables passing through the firewall for a series of entries (FIG. 5 and FIG. 7), and a response to a TEARDOWN command deletes the entries and disables passing through the firewall. With this, even if a proxy server is not installed, security is provided against unauthorized attacks, such as masquerading.

(3) Advantages in the Embodiment

According to the structure described above, the contents of control-protocol commands are changed, if necessary, and the commands are relayed. Therefore, streaming contents and others can be easily transferred while security is sufficiently provided by a firewall.

More specifically, when a command is relayed from a client terminal disposed inside the firewall to a server terminal disposed outside the firewall, a gateway apparatus which serves as a data transfer apparatus changes a port number in the command to a port number which can be used for transport protocol, and sends the command; the correspondence between address information and port numbers which can be used, in the gateway apparatus, and address information and port numbers in the client terminal is recorded; and the contents of the NAT table or the NAPT table 12A are updated according to the recordings. Therefore, commands can be relayed from the client terminal disposed inside the firewall to the server terminal disposed outside the firewall.

When a response command to such a command is obtained, it is determined whether the port number has been input in the NAT table or the NAPT table 12A; and as a result, the port number in the response is changed to a port number which the client terminal has assigned for transport protocol, and the response is sent. Therefore, responses to commands can be relayed from the client terminal disposed inside the firewall to the server terminal disposed outside the firewall.

When a command is relayed from a server terminal disposed inside the firewall to a client terminal disposed outside the firewall, the gateway apparatus changes a port number in the command to a port number which can be used for transport protocol, and sends the command; the correspondence between address information and port numbers which can be used, in the gateway apparatus, and address information and port numbers in the server terminal is recorded; and the contents of the NAT table or the NAPT table 12A are updated according to the recordings. Therefore, commands can be relayed from the server terminal disposed inside the firewall to the client terminal disposed outside the firewall.

In this case, passing through the firewall is dynamically enabled and disabled in the NAT table or the NAPT table 12A according to the setting and release of a session for a transport protocol. In addition, the address of a server terminal disposed outside the firewall is added to the filtering condition provided by the firewall function. Therefore, security is provided sufficiently.

(4) Other Embodiments

In the above-described embodiment, a case in which the present invention is applied to RTP data transfer, and streaming-content data is transferred has been described. The present invention is not limited to this case. The present invention can be widely applied to transfer of various types of data, in which a port number used by a transport protocol is dynamically specified by a control protocol.

In the above-described embodiment, a case in which the present invention is applied to a gateway apparatus has been described. The present invention is not limited to this case. The present invention can be widely applied to various units having such an application gateway function and such a firewall function, on networks.

In the above-described embodiment, a case in which data is transferred between the Internet and the local area network, which form a global address space and a private address space, respectively, has been described. The present invention is not limited to this case. The present invention can be widely applied to a case in which data is transferred between two networks, for example, a WAN and a LAN both of which form private address spaces.

As described above, according to the present invention, the contents of control-protocol commands are changed, if necessary, and the commands are relayed. Therefore, streaming contents and others can be transferred while security is sufficiently provided by a firewall.

### Industrial Applicability

The present invention relates to data transfer apparatuses, data transfer methods, and programs for data transfer methods, and can be applied, for example, to a gateway apparatus in a home network.

1. A data transfer apparatus connected between first and second networks, for transferring designated information between the first and second networks, characterized by comprising:
data input-and-output means connected to first and second terminals belonging to the first and second networks, respectively, through the first and second networks;
storage means for storing a parameter used for relay processing of information to be transmitted and received between the first and second terminals; and
data processing means for executing processing related to relaying of data transfer performed according to a transport protocol, the data being transmitted and received between the first and second terminals, and of command transfer performed according to a control protocol for the data transfer performed according to the transport protocol; and
characterized in that,
when the data input-and-output means receives a command sent according to the control protocol, the data processing means changes a parameter related to the transport protocol in the command, sends the command having the changed parameter, sent according to the control protocol, through the data input-and-output means, and stores the changed parameter related to the transport protocol in the storage means, and
when the data input-and-output means receives data sent according to the transport protocol, the data processing means applies relay processing to the data according to the parameter stored in the storage means.

2. A data transfer apparatus according to claim 1, characterized in that
the command sent according to the control protocol is
a command which is sent according to the control protocol and which includes information of a port number assigned by the first terminal, used for transferring data according to the transport protocol, and
the data processing means
rewrites at least a port number for the transport protocol, included in the command to a port number which can be used to change the parameter related to the transport protocol in the command,
transmits the command in which the port number has been rewritten to send the command having the changed parameter, sent according to the control protocol, through the data input-and-output means, and
associates the port number assigned by the first terminal with the rewritten port number and stores them to store the changed parameter related to the transport protocol in the storage means.

3. A data transfer apparatus according to claim 2, characterized in that
the data processing means
stores address information of the first terminal and address information of the second terminal in the storage means in association with the port number assigned by the first terminal and the rewritten port number.

4. A data transfer apparatus according to claim 1, characterized in that
the first terminal has a private address;
the second terminal has a global address; and
the data sent according to the transport protocol is data sent from the second terminal, having the global address, to the first terminal, having the private address.

5. A data transfer apparatus according to claim 1, characterized in that
the first terminal has a private address;
the second terminal has a global address; and
the data sent according to the transport protocol is data sent from the first terminal, having the private address, to the second terminal, having the global address.

6. A data transfer apparatus according to claim 2, characterized in that
when the data input-and-output means receives a command which is sent from the second terminal to the first terminal according to the control protocol and which includes information of a port number used for transferring data according to the transport protocol, the data processing means
determines whether the port number in the command has been input in the storage means, and
rewrites the port number for the transport protocol in the command to the port number assigned by the first terminal, stored in the storage means, and sends, according to the result of determination.

7. A data transfer apparatus according to claim 1, characterized in that
the data processing means
forms a firewall between the first and second networks, and
dynamically switches the condition of filtering performed by the firewall, according to a command sent according to the control protocol.

8. A data transfer apparatus according to claim 7, characterized in that
the data processing means associates address information of the first terminal in addition to a port number assigned by the first terminal and a rewritten port number and stores in the storage means, and
the condition of filtering performed by the firewall is address information of the first terminal, stored in the storage means.

9. A data transfer apparatus according to claim 1, characterized in that
the transport protocol is an RTP (real-time transport protocol), and
the control protocol is an RTSP (real-time streaming protocol).

10. A data transfer method for transferring designated information between first and second networks, characterized by comprising:
a control-protocol relay step of applying relay processing to a command transmitted and received according to a control protocol between first and second terminals belonging to the first and second networks, respectively, and of setting a parameter used for a transport protocol according to which data is transferred between the first and second terminals, according to a parameter in the command; and
a transport-protocol relay step of applying relay processing to data transfer performed according to the transport protocol between the first and second terminals, according to the parameter specified in the control-protocol relay step, and
characterized in that, in the control-protocol relay step, a parameter related to the transport protocol and disposed in the command sent according to the control protocol is changed, and the changed command sent according to the control protocol is output.

11. A program for a data transfer method for transferring designated information between first and second networks, characterized by comprising:
a control-protocol relay step of applying relay processing to a command transmitted and received according to a control protocol between first and second terminals belonging to the first and second networks, respectively, and of setting a parameter used for a transport protocol according to which data is transferred between the first and second terminals, according to a parameter in the command; and
a transport-protocol relay step of applying relay processing to data transfer performed according to the transport protocol between the first and second terminals, according to the parameter specified in the control-protocol relay step, and
characterized in that, in the control-protocol relay step, a parameter related to the transport protocol and disposed in the command sent according to the control protocol is changed, and the changed command sent according to the control protocol is output.
